(19) United States
(12) Patent Application Publication
(10) Pub. No.: US 2004/0146228 A1
(43) Pub. Date: Jul. 29, 2004

(54) Linear motion guide device

(76) Inventors: Mao Tu Lee, Chong Ho City (TW); Chin Hsiang Wang, Chong Ho City (TW)

Correspondence Address: Mao Tu LEE & Chin Hsiang WANG, P.O. Box 10-69, Chong Ho, Taipei, 235, TW

(21) Appl. No.: 10/355,908

(22) Filed: Jan. 29, 2003

(51) Int. Cl. F16C 29/06

(52) U.S. Cl. 384/45

(57) ABSTRACT

A linear motion guide device includes a sliding member having a frame slidably engaged onto an elongate track, a casing engaged into the frame and having one or two beams extended into the frame, a number of rotary members received between the elongate track and the beams of the casing. One or more stops may be secured onto the frame, to secure the casing to the frame. The frame and the casing may thus be stably secured onto the elongate track with the rotary members, without additional fasteners or tools. One or more pressing members may further be engaged onto the rotary members, to stably position the rotary members in the elongate track.

### BACKGROUND OF THE INVENTION

1. Field of the Invention

The present invention relates to a linear motion guide device, and more particularly to a linear motion guide device having improved ball or roller guiding mechanisms for facilitating the sliding movements between objects.

2. Description of the Prior Art

Typical bearings are provided and engaged between two rotary members, for facilitating the rotational movements between the two rotary members.

However, when two objects are slidably engaged or coupled with each other, no suitable linear motion guide devices have been provided for facilitating the sliding movements between the two slidable objects.

The present invention has arisen to mitigate and/or obviate the afore-described disadvantages of the conventional objects that are slidably coupled with each other.

### SUMMARY OF THE INVENTION

The primary objective of the present invention is to provide a linear motion guide device having an improved ball or roller guiding mechanism for facilitating the sliding movements between sliding objects.

In accordance with one aspect of the invention, there is provided a linear motion guide device comprising an elongate track including at least one longitudinal groove formed therein, a frame slidably engaged onto the elongate track, and movable along the elongate track, a casing engaged into the frame, and including at least one beam extended therefrom and received in the frame, a plurality of rotary members received between the elongate track and the beam of the casing, and received in the longitudinal groove of the elongate track, to facilitate a sliding movement of the frame and the casing along the elongate track, and means for securing the casing to the frame. The frame and the casing may thus be stably and slidably engaged onto the elongate track with the rotary members, and may be retained or secured onto the elongate track without additional fasteners or tools.

The beam of the casing includes a longitudinal slot formed therein to slidably receive the rotary members therein. The frame includes two side panels each having a longitudinal depression formed therein to receive the beam of the casing. The frame includes two end plates each having an opening formed therein, to slidably receive the elongate track therein.

The securing means includes at least one latch extended from each of the end plates of the frame, and two stops engaged with the latch of the end plates, to secure the stops to the end plates of the frame respectively. The stops each may include a projection extended therefrom and engaged with the casing, in order to position the casing in the frame.

The casing includes two ends each having a recess formed therein to receive the projection, and includes two side flanges engaged onto the side panels respectively. Two covers may further be provided and secured onto the stops respectively, to enclose the stops respectively.

One or more pressing members may further be provided and engaged onto the rotary members, to stably position the rotary members in the longitudinal groove of the elongate track. The pressing member may each include two ends positioned and secured between the respective side panels of the frame and the respective side flanges of the casing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating a linear motion guide device in accordance with the present invention;

FIG. 2 is an exploded view of the linear motion guide device; and

FIG. 3 is a bottom perspective view of the linear motion guide device.

### DETAILED DESCRIPTION OF THE PREFERRED EMBODIMENT

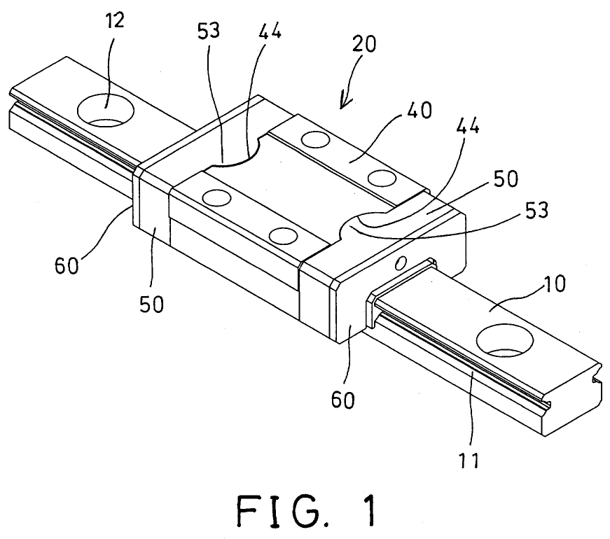

Referring to the drawings, and initially to FIG. 1, a linear motion guide device in accordance with the present invention is provided for being disposed in various kinds of apparatus, such as computers, machines, etc., for facilitating sliding movements between two or more relative slidable objects.

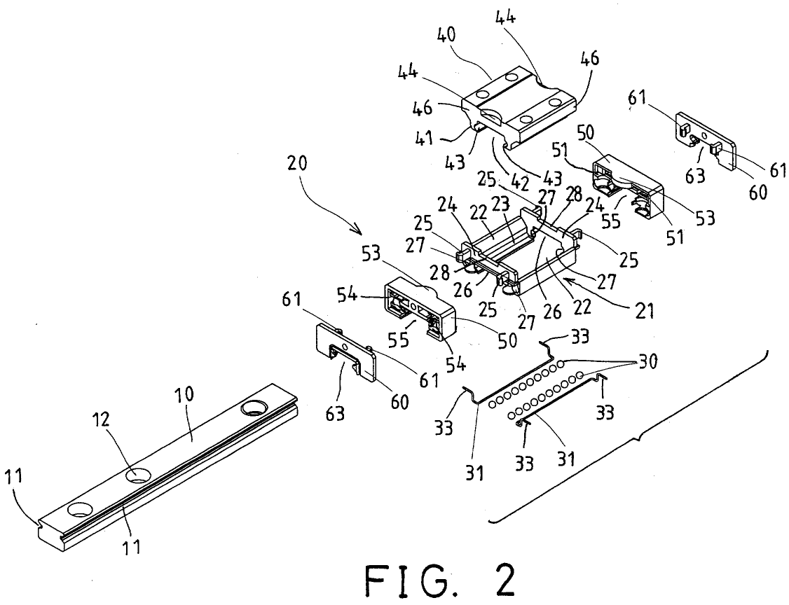

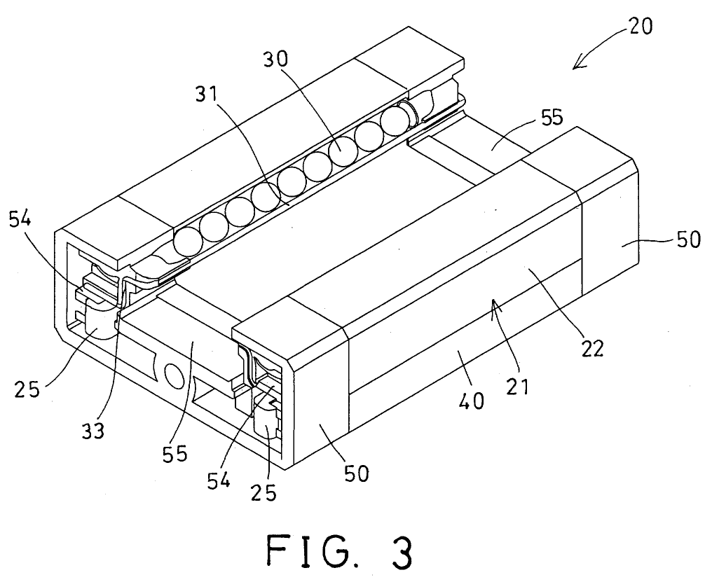

For example, as shown in FIGS. 2 and 3, the linear motion guide device comprises an elongate member 10, such as an elongate track 10 including one or two sides each having a longitudinal groove 11 formed therein for slidably receiving rotary members 30, such as balls, rollers, etc. therein. The elongate track 10 may include one or more holes 12 formed therein for such as weight reducing purposes.

A sliding member 20 is to be slidably engaged onto and movable along the elongate track 10, and includes a frame 21 having a pair of side panels 22 and two end plates 24 secured between the ends of the side panels 22 respectively, in order to form a substantially parallelogrammic structure. The side panels 22 each may include a longitudinal depression 23 formed therein. The end plates 24 each may include an opening 26 formed therein, such as formed in the lower portion thereof, to slidably receive the elongate track 10 therein. The end plates 24 each may include two notches 27 formed therein and communicating with the opening 26 thereof, and each may include an indentation 28 formed in the upper portion thereof, and each may include one or more hooks or fasteners or latches 25 extended therefrom.

A casing 40 is engaged into the frame 21, and disposed between the end plates 24 of the frame 21, such that the casing 40 may be retained in the frame 21 and may be moved in concert with the frame 21 relative to the elongate track 10. The casing 40 includes one or more, such as two beams 41 extended downwardly therefrom and engaged into the longitudinal depression 23 of the side panels 22 of the frame 21 respectively. The casing 40 includes a channel 42 formed or defined between the beams 41 to partially receiving the longitudinal track 10, such as to partially receiving the upper portion of the longitudinal track 10.

The beams 41 each may include a longitudinal slot 43 formed therein and communicating with the channel 42 thereof, to slidably receive the rotary members 30 therein. The rotary members 30 may thus be received in the longitudinal slots 43 of the beams 41 and the longitudinal grooves 11 of the elongate track 10 respectively, and may thus be stably retained between the beams 41 and the elongate track 10, to facilitate the sliding movement between the sliding member 20 and the elongate track 10.

For example, the rotary members 30, such as the balls or rollers of the linear motion guide device may form or provide contact points between the elongate track 10 and the beams 41 of the casing 40, and may thus reduce the contact areas between the elongate track 10 and the beams 41 of the casing 40, such that the sliding movement between the sliding member 20 relative to the elongate track 10 may be facilitated or improved.

One or more, such as two pressing members 31 may further be provided to engage with the rotary members 30, and to further stably retain the rotary members 30 between the beams 41 and the elongate track 10, and thus to further facilitate the stably sliding movement between the sliding member 20 and the elongate track 10. For example, the pressing members 31 may include a longitudinal structure to engage with the rotary members 30, best shown in FIG. 3, and each may include two bent ends 33 engaged onto or straddled or supported on the side panels 22 of the frame 21.

The casing 40 includes two end portions each having a recess 44 formed therein, and includes two side flanges 46 to be engaged onto or straddled or supported on the side panels 22 of the frame 21. The bent ends 33 of the pressing members 31 may thus be positioned or clamped or secured between the side panels 22 of the frame 21 and the side flanges 46 of the casing 40 respectively.

Two stops 50 are to be engaged onto or secured to the ends of the frame 21. For example, the stops 50 each may include one or more, such as two lock cavities 51 formed therein to receive the latches 25 of the frame 21 respectively, which may easily and readily secure the stops 50 to the frame 21 without additional fasteners or tools. The stops 50 may engage with the rotary members 30, to further stably retain the rotary members 30 between the beams 41 and the elongate track 10.

The stops 50 each may include a projection 53 extended therefrom, and engaged into the respective indentations 28 of the frame 21 and the recesses 44 of the casing 40, so as to secure or to lock and to retain the casing 40 in the frame 21. The frame 21 and the casing 40 and the stops 50 may thus be moved in concert with each other, relative to or along the elongate track 10. The stops 50 each may also include an opening 55 formed therein, such as formed in the lower portion thereof, to slidably receive the elongate track 10 therein.

The stops 50 each may include one or more, such as two lock cavities 54 formed therein, such as formed in the outer portion thereof. Two covers 60 may further be provided and may include one or more, such as two hooks or fasteners or catches 61 extended therefrom, and engageable into the lock cavities 54 of the stops 50 respectively, for securing the covers 60 onto the stops 50, and in order to shielding or blocking the ends of the stops 50, and so as to form a smooth or complete outer appearance for the sliding member 20.

The covers 60 each may also include an opening 63 formed therein, such as formed in the lower portion thereof, to slidably receive the elongate track 10 therein. Alternatively, the covers 60 may also be directly formed integral with the stops 50 respectively, without additional securing or fastener members.

In assembling the linear motion guide device, the frame 21 is first engaged onto the elongate track 10, or the elongate track 10 is engaged into the openings 26 of the end plates 24. The rotary members 30 may then be engaged into the longitudinal grooves 11 of the elongate track 10 respectively. The pressing members 31 may then be engaged with the rotary members 30, to stably retain the rotary members 30 in the longitudinal grooves 11 of the elongate track 10.

The beams 41 of the casing 40 may then be engaged into the frame 21, and engaged between the rotary members 30 and the elongate track 10, and received in the longitudinal slots 43 of the beams 41 and the longitudinal grooves 11 of the elongate track 10 respectively. The side flanges 46 of the casing 40 may engage with the bent ends 33 of the pressing members 31 so as to secure and retain the pressing members 31 between the frame 21 and the casing 40.

The stops 50 may then be secured onto the ends of the frame 21, in order to secure and retain the casing 40 to the frame 21. The covers 60 may then be optionally or selectively engaged or secured onto the ends of the stops 50, in order to form a smooth or complete outer appearance for the sliding member 20. The sliding member 20 may thus be easily and readily and slidably secured onto the elongate track 10 without additional fasteners and tools.

In operation, the elongate track 10 may be provided or secured in various kinds of apparatus, such as computers, machines, etc., and the other objects may be secured onto the frame 21 or the casing 40 of the sliding member 20, for allowing the objects to be smoothly and stably supported and slid along the elongate track 10.

Accordingly, the linear motion guide device in accordance with the present invention includes an improved ball or roller guiding mechanism for facilitating the sliding movements between sliding member and the elongate track.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A linear motion guide device comprising:
an elongate track including at least one longitudinal groove formed therein,
a frame slidably engaged onto said elongate track, and movable along said elongate track,
a casing engaged into said frame, and including at least one beam extended therefrom and received in said frame,
a plurality of rotary members received between said elongate track and said at least one beam of said casing, and received in said at least one longitudinal groove of said elongate track, to facilitate a sliding movement of said frame and said casing along said elongate track, and
means for securing said casing to said frame.

2. The linear motion guide device as claimed in claim 1, wherein said at least one beam of said casing includes a longitudinal slot formed therein to slidably receive said rotary members therein.

3. The linear motion guide device as claimed in claim 1, wherein said frame includes two side panels each having a longitudinal depression formed therein to receive said at least one beam of said casing.

4. The linear motion guide device as claimed in claim 1, wherein said frame includes two end plates each having an opening formed therein, to slidably receive said elongate track therein.

5. The linear motion guide device as claimed in claim 1, wherein said frame includes two end plates, said securing means includes at least one latch extended from each of said end plates of said frame, and two stops engaged with said at least one latch of said end plates, to secure said stops to said end plates of said frame respectively.

6. The linear motion guide device as claimed in claim 5, wherein said stops each may include a projection extended therefrom and engaged with said casing, to position said casing in said frame.

7. The linear motion guide device as claimed in claim 6, wherein said casing includes two ends each having a recess formed therein to receive said projection.

8. The linear motion guide device as claimed in claim 5, wherein said frame includes two side panels, said casing includes two side flanges engaged onto said side panels respectively.

9. The linear motion guide device as claimed in claim 5 further comprising two covers secured onto said stops respectively, to enclose said stops respectively.

10. The linear motion guide device as claimed in claim 1 further comprising at least one pressing member engaged onto said rotary members, to retain said rotary members in said at least one longitudinal groove of said elongate track.

11. The linear motion guide device as claimed in claim 10, wherein said frame includes two side panels, said casing includes two side flanges engaged onto said side panels respectively, said at least one pressing member includes two ends positioned between one of said side panels of said frame and one of said side flanges of said casing.
